(19) United States
(12) Patent Application Publication
(10) Pub. No.: US 2001/0008024 A1
(43) Pub. Date: Jul. 12, 2001

(54) Upgrade control method and data processing system

(76) Inventor: Toru Inaba, Yokohama (JP)

Correspondence Address: Helfgott & Karas, P.C., Suite 6024, 350 Fifth Avenue, New York, NY, 10118, US

(21) Appl. No.: 09/797,490

(22) Filed: Mar. 1, 2001

Related U.S. Application Data
(63) Continuation of application No. PCT/JP99/03294, filed on Jun. 21, 1999.

(30) Foreign Application Priority Data
Sep. 4, 1998 (JP) 10-251033

(51) Int. Cl. G06F 9/44

(52) U.S. Cl. 717/11

(57) ABSTRACT

The invention relates to an upgrade control method and data processing system for system operational data and software, and performs an upgrade without interrupting or stopping service. The data processing system comprises: a system operational data storing unit 7 which stores therein system operational data and version information; a system version management information storing unit 8 which stores therein system acceptable software and system version information; a database version verification unit 2 which, when performing an upgrade, verifies based on the version information whether or not the upgrade is acceptable by the system; a database conversion unit 5 which converts the format of the system operational data; and a power-up control unit 4 which issues a start-up request to a system functional group 6, and wherein: when performing an upgrade, verification is made based on the version information to determine whether or not the upgrade is acceptable by the system and, if the upgrade is acceptable, the power-up control unit 4 issues the start-up request to the system functional group 6 and the system operational data is converted to the latest format but, if the upgrade is not acceptable, the current operational state is maintained and a mismatched state is reported.

### CROSS-REFERENCE TO RELATED APPLICATIONS

This application is based upon and claims the priority of Japanese Patent Application No. 10-251033, filed Sep. 4, 1998, the contents being incorporated herein by reference, and a continuation of PCT/JP99/03294.

### TECHNICAL FIELD

The present invention relates to an upgrade control method and data processing system for system operational data and software.

In a data processing system including a data transmission apparatus, exchange apparatus, etc., system operational data used to set up the operations of various units is stored in a database, and software executes various processing operations using the system operational data. Such software or system operational data may be upgraded by downloading or other operations, and it is desired to make provisions so that the service that the data processing system is providing will not be interrupted during the upgrading.

### BACKGROUND ART

A data processing system such as a data transmission apparatus or exchange apparatus for voice, video, data, etc., carries out various services such as data transmission and exchange services by using system operational data. The system operational data is initially set up as default values and stored in a database, and system power-up is performed by making necessary settings such as additions or changes to the system operational data in accordance with the actual operating environment of the system processing system.

A data processing system comprises various unit apparatuses including apparatuses equipped with software. There are also cases where a unit apparatus is added or changed to match the operating environment of the system, and in such cases, a unit apparatus whose software is upgraded may have to be incorporated into the system. To enhance data reliability, the system also includes the function of detecting corruption of the system operational data and the function of detecting corruption of program management data.

Further, in a data processing system comprising a plurality of data transmission apparatuses interconnected via a local area network (LAN), there may be cases where some data transmission apparatuses are equipped with different versions of software, and when system operational data is downloaded between the apparatuses or from a control and monitoring terminal or the like, some of the software may not be able to recognize the system operational data. If this happens, the possibility of erroneous operation would increase; therefore, the operational state of the system is forced to the state that uses the default values of the system operational data.

Generally, a data processing system is required to provide uninterrupted service. However, in the prior known data processing system, when a unit apparatus equipped with software is added or changed, or when software is downloaded under control of the control and monitoring terminal, if there occurs a difference, for example, in check code, the operational state of the system is reset to the default values of the system operational data. This causes an interruption in service.

Furthermore, when a unit apparatus equipped with software is added or changed to upgrade the function of the data processing system, if the software does not match the version of the system operational data, for example, if the upgraded software cannot recognize the system operational data currently in use, there occurs the problem that the service being provided based on the current system operational data stops.

### DISCLOSURE OF THE INVENTION

It is an object of the present invention to enable an upgrade to be accomplished without causing interruptions in service.

The present invention provides an upgrade control method (1) wherein version information is appended to system operational data used when executing software in a data processing system, and wherein when performing an upgrade, verification is made based on the version information to determine whether or not the upgrade is acceptable by the system and, if the upgrade is acceptable, the system moves into an operational state that matches the result of the upgrade, but if the upgrade is not acceptable, the system maintains the current operational state before the upgrade.

In a preferred mode (2), when upgrading the software through downloading, verification is made based on the version information of the system operational data to determine whether or not the upgrade is acceptable by the system and, if the upgrade is acceptable but the system operational data is older than the upgraded software in terms of version, the system operational data is converted to a format recognizable by the upgraded software and the version information of the system operational data is updated accordingly.

In a preferred mode (3), when upgrading the software through downloading, verification is made based on the version information of the system operational data to determine whether or not the upgrade is acceptable by the system and, if the upgrade is not acceptable, system operation is continued using the current system operational data and an alarm indication indicating an unacceptable state is produced.

In a preferred mode (4), when performing an upgrade as a result of replacing a unit apparatus equipped with software, verification is made as to whether or not the software is acceptable, based on the version information of the system operational data, and if the software is acceptable, the system operational data is converted to a format recognizable by the upgraded software and the version information is updated accordingly, but if the software is not acceptable, system operation is continued using the current system operational data and an alarm indication indicating an unacceptable state is produced.

In a preferred mode (5), when the system operational data is downloaded, verification is made based on the version information to determine whether or not the downloaded system operational data is acceptable by the system and, if the system operational data is acceptable but the version information of the system operational data is older than the current system, the system operational data is converted to a format recognizable by the current system and the version information is updated accordingly, but if the system operational data is not acceptable, system operation is continued using the current system operational data and an alarm indication is produced.

The invention also provides a data processing system (6) in which system operational data and software are upgradable, comprising: a system operational data storing unit 7 which stores therein the system operational data and version information of the system operational data; a system version management information storing unit 8 which stores therein system acceptable software and system version information; a database version verification unit 2 which, when performing an upgrade, verifies, based on the version information, whether or not the upgrade is acceptable by the system; and a power-up control unit 4 which controls power-up of a system functional group 6 only when the result of the verification in the database version verification unit 2 shows a system acceptable state.

In a preferred mode (7), the data processing system includes a database conversion unit 5 which converts the system operational data to the latest format when the result of the verification in the database version verification unit 2 shows a system acceptable state, and when the version of the system operational data is not the latest version.

In a preferred mode (8), the database version verification unit 2 includes a facility for reporting a mismatched state to a control and monitoring terminal and causing a display unit to produce an alarm indication indicating the mismatched state when the result of the verification shows a system unacceptable state.

### BRIEF DESCRIPTION OF THE DRAWINGS

FIG. 1 is a diagram for explaining the principles of the present invention.

FIG. 2 is a diagram for explaining an essential portion of an embodiment of the present invention.

FIG. 3 is a diagram for explaining system operational data and system version management information used in the embodiment of the present invention.

FIG. 4 is a flowchart illustrating a version verification procedure according to the embodiment of the present invention.

### BEST MODE FOR CARRYING OUT THE INVENTION

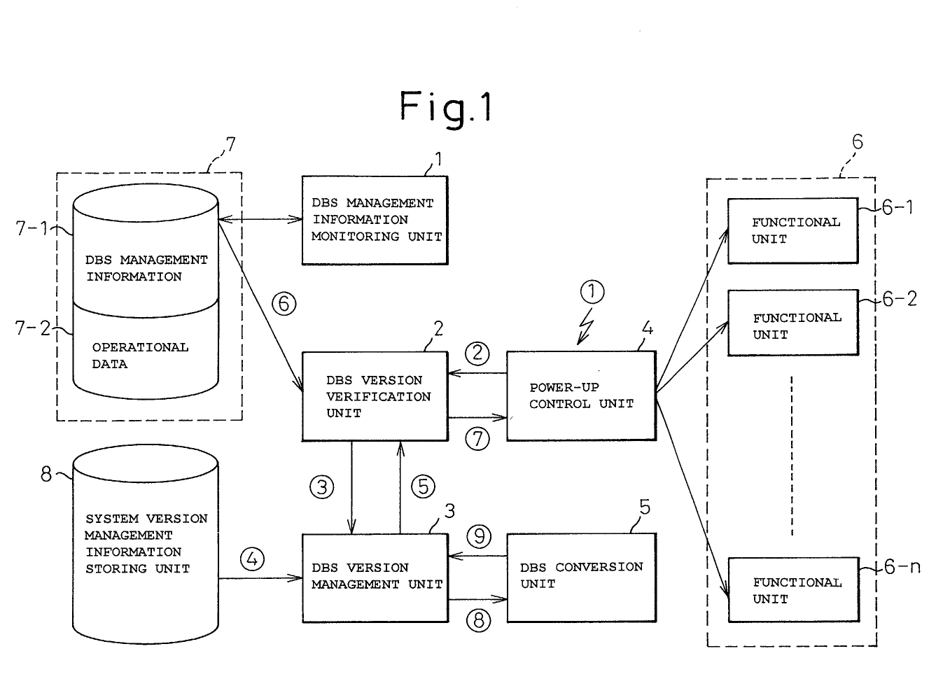

FIG. 1 is a diagram for explaining the principles of the present invention, wherein reference numeral 1 is a database (DBS) management information monitoring unit, 2 is a database (DBS) version verification unit, 3 is a database (DBS) version management unit, 4 is a power-up control unit, 5 is a database (DBS) conversion unit, 6 is a system functional group, 6-1 to 6-n are system functional units, 7 is a system operational data storing unit, 7-1 is database (DBS) management information, 7-2 is operational data, and 8 is a system version management information storing unit. The system operational data storing unit 7 and the system version management information storing unit 8 together constitute the database in the data processing system. Further, circled numbers \mathring{1} to \mathring{9} indicate one example of an operational sequence when performing an upgrade.

The database (hereinafter abbreviated DBS) management information monitoring unit 1 periodically monitors the DBS management information 7-1 in the system operational data storing unit 7 and applies repair and other operations to the version information to maintain the reliability of the system operational data storing unit 7. The DBS version verification unit 2, during an upgrade operation, compares the version of the master DBS with the DBS version registered in the system version information, and verifies whether the version is acceptable or not. The DBS version management unit 3 manages the system version information stored in the system version management information storing unit 8. The power-up control unit 4 controls the functional units 6-1 to 6-n together or individually.

When the DBS version is a version acceptable by the system, but is not the latest version, the DBS conversion unit 5 converts the system operational data format to the latest format that can be recognized by the upgraded software. The DBS management information 7-1 in the system operational data storing unit 7 is management information including DBS version, etc., and the operational data 7-2 contains various setup data necessary for system operation. The system version management information storing unit 8 stores the version information for software and DBS versions acceptable by the system.

Upon reception of hardware reset (unit apparatus reset) or other information \mathring{1} at power on or at the time of software downloading, the power-up control unit 4 sends a DBS version verify request \mathring{2} to the DBS version verification unit 2. The DBS version verification unit 2 issues an acceptable DBS version acquire request \mathring{3} to the DBS version management unit 3 which, in response, acquires system DBS version information \mathring{4} from the system version management information storing unit 8 and sends the system DBS version information as response information \mathring{5} to the DBS version verification unit 2.

The DBS version verification unit 2 also acquires the version information \mathring{6} of the system operational data from the system operational data storing unit 7, compares it with the system DBS version information received as the response information \mathring{5} to verify whether the version is acceptable by (compatible with) the system, and sends the result of the verification to the power-up control unit 4 as a response \mathring{7} to the DBS version verify request \mathring{2}. If the result of the verification shows that the version is acceptable, the power-up control unit 4 sends a start-up request to the functional units 6-1 to 6-n in the system functional group 6. On the other hand, if the result of the verification shows that the version is not acceptable (not compatible), an alarm indication is produced using a function not shown.

When the result of the verification from the DBS version verification unit 2 shows that the version is acceptable by the system, but is not the latest version, the DBS version management unit 3 sends a convert request \mathring{8} to the DBS conversion unit 5 for the conversion of the system operational data to the latest format. The DBS conversion unit 5 converts the system operational data to the latest format so that it can be recognized by the upgraded software, and sends a completion response \mathring{9} to the DBS version management unit 3.

As described above, when performing an upgrade, the version of the system operational data is verified, and if the version is verified as acceptable, the system operational data is converted to the latest format that can be recognized and processed by the software; in this way, the upgrade can be accomplished without interrupting the service. If the version is not acceptable, on the other hand, the current operational state is maintained, and an alarm indication is produced. Service interruption in the case of an unacceptable version can thus be avoided.

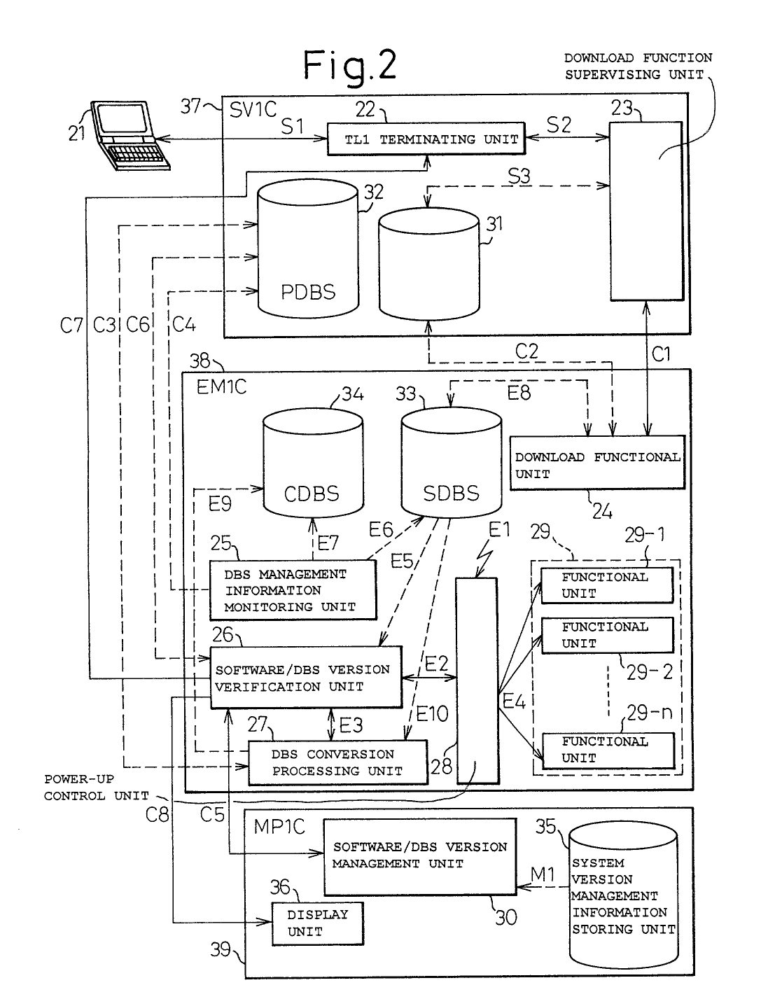

FIG. 2 is a diagram for explaining an essential portion of an embodiment of the present invention, wherein reference numeral 21 is a control and monitoring terminal, 22 is a TL1 terminating unit, 23 is a download function supervising unit, 24 is a subscriber download functional unit, 25 is a DBS management information monitoring unit, 26 is a software/DBS version verification unit, 27 is a DBS conversion processing unit, 28 is a power-up control unit, 29 is a system functional group, 29-1 to 29-n are functional units, and 30 is a software/DBS version management unit.

Further, reference numeral 31 is a memory constructed, for example, from a hard disk or the like, 32 is a primary database (PDBS) constructed, for example, from a random-access memory (RAM) or the like having a backup function, 33 is a secondary database (SDBS) constructed from a nonvolatile EEPROM or the like, 34 is a working database (CDBS) constructed from a random-access memory or the like, 35 is a system version management information storing unit, 36 is a display unit, 37 is a SVIC unit, 38 is an EMIC unit, and 39 is a MPIC unit, the diagram thus showing an essential portion of a data processing system. Reference characters S1 to S3, C1 to C8, E1 to E10, and M1 indicate signals transferred between various units.

The units having the same names as those in FIG. 1 are identical in function to the corresponding units shown in FIG. 1, while on the other hand, the software/DBS version verification unit 26 corresponds to the DBS version verification unit 2, the DBS conversion processing unit 27 corresponds to the DBS conversion unit 5, the software/DBS version management unit 30 corresponds to the DBS version management unit 3, the PDBS 32, SDBS 33, and CDBS 34 together correspond to the system operational data storing unit 7, and the system version management information storing unit 35, control and monitoring terminal 21, TL1 terminating unit 22, download function supervising unit 23, download functional unit 24, and memory 31 correspond in function to the system version management information storing unit 8.

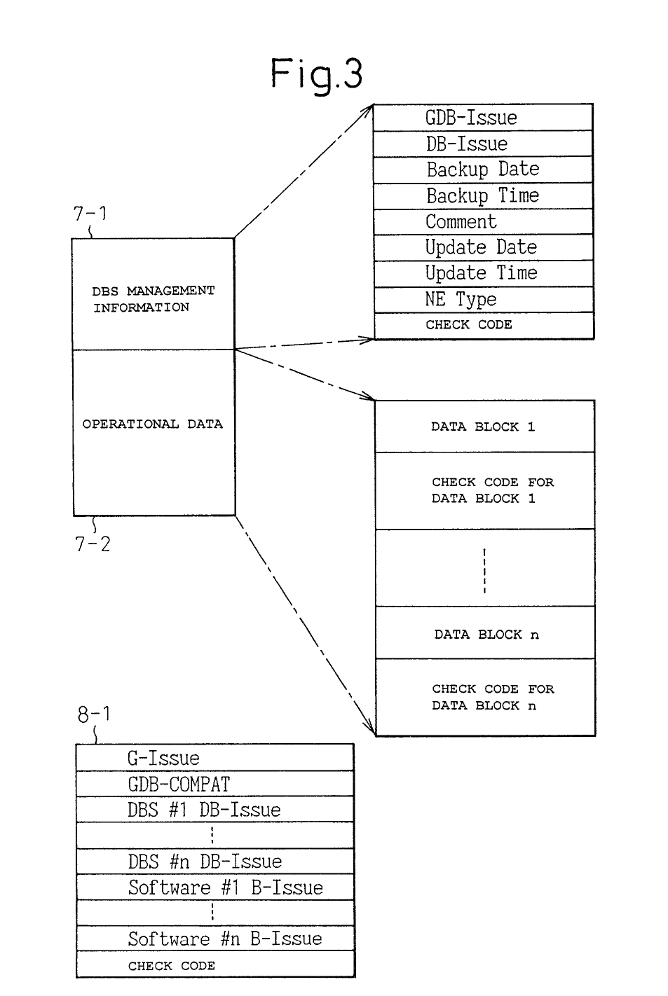

FIG. 3 is a diagram for explaining the system operational data and system version management information used in the embodiment of the present invention; the DBS management information 7-1 in the system operational data storing unit 7 (see FIG. 1) includes, as shown at the right, combination version information GDB-Issue, DBS version information DB-Issue, remote memory backup date Backup Date, remote memory backup time Backup Time, comment information Comment, database update date Update Date, database update time Update Time, apparatus type NE Type, and check code for the DBS management information. The operational data 7-2 managed by software includes data blocks 1 to n and check codes for the respective data blocks.

On the other hand, the system version management information 8-1 in the system version management information storing unit 8 (see FIG. 1) includes system version information G-Issue, system acceptable combination version information GDB-COMPAT, DBS version information DBS#1DB-Issue to DBS#nDB-Issue, software version information Software#1B-Issue to Software#nB-Issue, and a check code for the system version management information.

FIG. 2 shows the case where various requests and responses are transferred between the control and monitoring terminal 21 and the SVIC unit 37 by using TL1 messages; for example, when the control and monitoring terminal 21 sends a software download request (S1), the request is terminated at the TL1 terminating unit 22 and the download request (S2) is transferred to the download function supervising unit 23. The download function supervising unit 23 downloads the software (S3) to the memory 31 in accordance with the download request (S2), and when the transfer of the software to the memory 31 is completed, the download function supervising unit 23 sends a download completion notification (S2, S1) to the control and monitoring terminal 21 via the TL1 terminating unit 22.

Thereupon, the control and monitoring unit 21 issues a software write request (S1, S2) to the download function supervising unit 23 via the TL1 terminating unit 22. In response, the download function supervising unit 23 or the download functional unit 24 carries out the writing of the software temporarily stored in the memory 31 (S3, C1, C2) (writing to a software storing unit not shown).

At the completion of the writing, the download function supervising unit 23 or the download functional unit 24 sends a write result notification (S1, S2) to the control and monitoring terminal 21 to notify whether the writing has been completed normally or terminated abnormally. When the writing has been competed normally, the control and monitoring unit 21 sends a software switchover request (S1, S2) to the download function supervising unit 23 via the TL1 terminating unit 22. In response, the download function supervising unit 23 and the download functional unit 24 carry out the switchover of software for the respective unit apparatuses. This causes a hardware reset (E1).

Upon the hardware reset (E1), the power-up control unit 28 issues a version verify request (E2) to the software/DBS version verification unit 26. The software/DBS version verification unit 26 issues a system version information request (C5) to the software/DBS version management unit 30. In response to the request (C5), the software/DBS version management unit 30 acquires system version management information (M1) from the system version management information storing unit 35, and sends a notification (C5) to the software/DBS version verification unit 26.

The software/DBS version verification unit 26 determines the master DBS, acquires the combination version information GDB-Issue (C6 or E5) (see FIG. 3) for the master DBS from the DBS management information 7-1, and compares it with the DBS version information DB-Issue in the system version management information 8-1 to check the DBS version for a mismatch.

If the version matches the system acceptable DBS version GDB-COMPAT, but the format is not the latest DBS format, the software/DBS version verification unit 26 issues a DBS convert request (E3) to the DBS conversion processing unit 27. The DBS conversion processing unit 27 takes in the contents of the master DBS, converts the format to the latest system operational data format, and stores the data in the CDBS 34 (E9). The system operational data is now recognizable by the upgraded software. Then, a conversion completion notification (E3) is sent to the software/DBS version verification unit 26. Thereupon, the software/DBS version verification unit 26 reports the result of the verification (E2) to the power-up control unit 28.

If the result of the verification (E2) shows a system acceptable state, the power-up control unit 28 issues a start-up request (E4) to the system functional group 29. The system thus moves into the operational state effected by the upgraded software. In this case, since the system operational data converted to the format recognizable by the upgraded software is stored in the CDBS 34, system operation using the upgraded software becomes possible without interrupting the service currently being provided.

On the other hand, if the result of the verification (E2) shows a system unacceptable state, the start-up request to the system operational group 29 is not issued. As a result, the current service state is maintained. Further, a version mismatch alarm indication request (C8) is issued to the display unit 36 while, at the same time, a mismatched state notification (C7) is sent via the TL terminating unit 22 to the control and monitoring terminal 21 and also to the download function supervising unit 23. The display unit 36 is constructed, for example, from a light-emitting diode, and can be configured to indicate the mismatched state in corresponding fashion to each unit apparatus, for example. Alternatively, the display unit 36 may be combined with a liquid crystal display panel so that various displays can be produced for viewing. By alerting the operator to the mismatched state by producing such an indication or display, proper upgrading can be carried out.

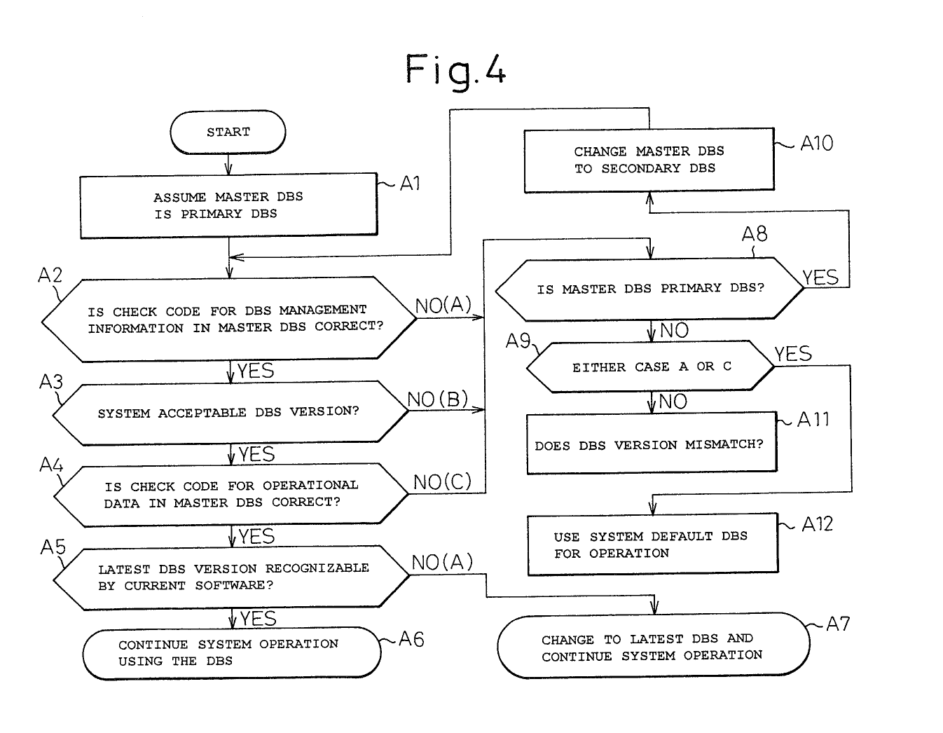

FIG. 4 is a flowchart illustrating a version verification procedure according to the embodiment of the present invention, dealing with the case where the software/DBS version verification unit 26 verifies the master DBS. First, it is assumed that the master DBS is the primary DBS (PDBS 32) (A1). Then, it is determined whether the check code for the DBS management information (8-1 in FIG. 3) in the master DBS is correct or not (A2). If the check code is correct, then the version is checked to determine whether it is a system acceptable DBS version (A3).

If the version is a system acceptable DBS version, then it is determined whether the check code for the operational data (7-2 in FIG. 3) in the master DBS is correct or not (A4). If the check code is correct, then the version is checked to determine whether it is the latest DBS version recognizable by the present software (A5). If it is recognizable, the current DBS continues to be used for operation (A6). If it is not the latest DBS version recognizable by the software, it is updated to the latest DBS, and the DBS continues to be used for operation (A7).

If the check code is determined to be not correct in step (A2) (case A), or if the version is determined to be an unacceptable DBS version in step (A3) (case B), or if the check code is determined to be not correct in step (A4) (case C), then it is determined whether the master DBS is the primary DBS (A8). If the primary DBS (PDBS 32) is the master DBS, the master DBS is changed to the secondary DBS (SDBS 33) (A10), and the process returns to step (A2).

If, in step (A8), the master DBS is the primary DBS (PDBS 32), then it is determined whether the originating case is either the case A or the case C (A9); if the originating case is either the case A or the case C, then the system default DBS is used for operation (A12), but if it is neither the case A nor the case C but the case B, then it is determined that a DBS version mismatched state has occurred (A11).

The control and monitoring terminal 21 can also issue a system operational data download request. In that case, the control and monitoring terminal 21 sends a DBS download request (S1, S2) to the download function supervising unit 23 via the TL1 terminating unit 22. The download function supervising unit 23 downloads the system operational data (S3) to the memory 31 and, at the completion of the download, sends a download completion notification (S1, S2) to the control and monitoring terminal 21 via the TL1 terminating unit 22.

Then, when the control and monitoring terminal 21 sends a DBS write request (S1, S2) to the download function supervising unit 23 via the TL1 terminating unit 22, the download function supervising unit 23 and the download functional unit 24 write the system operational data from the memory 31 (S3, C1, C2). At the completion of the writing, the download function supervising unit 23 or the download functional unit 24 sends a write completion notification (S1, S2) to the control and monitoring terminal 21 via the TL1 terminating unit 22.

Thereupon, the control and monitoring terminal 21 sends a DBS switchover request (S1, S2) via the TL1 terminating unit 22 to the download function supervising unit 23 and also to the download functional unit 24. The download function supervising unit 23 and the download functional unit 24 carry out the DBS switchover for the respective units. This causes a hardware reset (E1), upon which the power-up control unit 28 issues a version verify request (E2) to the software/DBS version verification unit 26, as in the case of the previously described software download.

Then, the DBS version is verified in the same manner as previously described; that is, if the version is a system acceptable DBS version, but the format is not the latest DBS format, then the DBS conversion processing unit 27 takes in the contents of the master DBS (C3, E10) (either PDBS 32 or SDBS 33 is the master DBS), converts the format to the latest DBS format, and stores the data in the CDBS 34 (E9). In the case of a normal completion, the power-up control unit 28 issues a start-up request (E4) to the system functional group 29. In this way, the system operation using the downloaded system operational data can be started.

On the other hand, if the DBS version has been determined to be a version not acceptable by the system, an alarm indication request (C8) is sent to the display unit 36 while, at the same time, a mismatched state notification (C7) is sent via the TL1 terminating unit 22 to the control and monitoring terminal 21 and also to the download function supervising unit 23; the power-up control unit 28 does not issue a start-up request to the system functional group 29. As a result, the current service state is maintained.

The control and monitoring terminal 21 can also issue a system operational data backup request (S1). In that case, the download function supervising unit 23 sends a DBS backup request (C1) to the download functional unit 24. In response, the download functional unit 24 reads the currently used DBS management information 7-1 and operational data 7-2 from the SDBS 33 (E8), and copies them to the memory 31 (C2). At the completion of the copying, the download functional unit 24 or the download function supervising unit 23 sends a completion notification to the control and monitoring terminal 21 via the TL1 terminating unit 22.

Then, the download function supervising unit 23 acquires data from the memory 31 (S3), and uploads the data to the control and monitoring terminal 21 via the TL1 terminating unit 22 (S1, S2). At the completion of the upload, the download functional unit 24 or the download function supervising unit 23 sends an upload completion notification to the control and monitoring terminal 21 via the TL1 terminating unit 22.

In the data processing system, there are cases where a unit apparatus equipped with software is replaced. AS a result of the replacement a hardware reset (E1) occurs, upon which the power-up control unit 28 issues a version verify request (E2) to the software/DBS version verification unit 26. The software/DBS version verification unit 26 then sends a system version request (C5) to the software/DBS version management unit 30.

The software/DBS version management unit 30 acquires system version management information (M1) from the system version management information storing unit 35, and transfers the system version management information to the software/DBS version verification unit 26. The software/DBS version verification unit 26 determines the master DBS in accordance with the process steps shown in FIG. 4, and acquires the DBS management information 7-1 from the master DBS. The software/DBS version verification unit 26 compares the DBS version information in the system version management information 8-1 with the DBS version information in the DBS management information of the master DBS, and checks the DBS version for a mismatch.

If the version is a system acceptable DBS version, but the format is not the latest DBS format, the software/DBS version verification unit 26 issues a DBS convert request (E3) to the DBS conversion processing unit 27, which then converts the data taken from the master DBS to the latest DBS format and stores the data in the CDBS 34 (E9). Then, the DBS conversion processing unit 27 sends a DBS conversion completion notification (E3) to the software/DBS version verification unit 26.

The software/DBS version verification unit 26 reports the result of the DBS version verification (E2) to the power-up control unit 28. Based on the result of the DBS version verification, the power-up control unit 28 determines whether or not to send a start-up request to the system functional group 29; if the result of the verification shows that the version is acceptable, the power-up control unit 28 issues the start-up request (E4). Operation that matches the environment after the replacement of the unit apparatus equipped with software can thus be started.

On the other hand, if the DBS version is a version that is not acceptable by the system, the software/DBS version verification unit 26 sends the result of the verification to the power-up control unit 28 and, at the same time, issues an alarm indication request (C8) to the display unit 36 and reports the DBS version mismatched state (C7) via the TL terminating unit 22 to the control and monitoring terminal 21. Since the result of the DBS version verification shows the mismatched state, the power-up control unit 28 does not issue a start-up request to the system functional group 29. Accordingly, the current service state can be maintained.

The present invention is not limited to the above-described embodiment, but various additions and modifications can be made; for example, a data processing system constructed from a single data transmission apparatus or exchange apparatus or the like, and a data processing system constructed from a plurality of data transmission apparatuses, exchange apparatuses, or the like, also fall within the scope of the invention.

As described above, based on version information of the system operation data and version information acceptable by the system, the software and system operational data are checked to determine whether the software or the system operational data is acceptable for proper operation of the system; if the software or the system operational data is not acceptable, an alarm indication is produced to alert the operator to the mismatched state, while maintaining the current system operational state; this serves to enhance the reliability of the system. On the other hand, if the software or the system operational data is acceptable by the system, the system operational data format is converted to the format recognizable by the upgraded software; this offers the advantage of being able to perform the upgrading smoothly without causing an interruption in service.

1. An upgrade control method wherein version information is appended to system operational data used when executing software in a data processing system, and wherein, when performing an upgrade, verification is made based on the version information to determine whether or not the upgrade is acceptable by the system and, if the upgrade is acceptable, the system moves into an operational state that matches the result of the upgrade, but if the upgrade is not acceptable, the system maintains the current operational state before the upgrade.

2. An upgrade control method as claimed in claim 1, wherein, when upgrading the software through downloading, verification is made based on the version information of the system operational data to determine whether or not the upgrade is acceptable by the system and, if the upgrade is acceptable but the system operational data is older than the upgraded software in terms of version, the system operational data is converted to a format recognizable by the upgraded software and the version information of the system operational data is updated accordingly.

3. An upgrade control method as claimed in claim 1, wherein, when upgrading the software through downloading, verification is made based on the version information of the system operational data to determine whether or not the upgrade is acceptable by the system and, if the upgrade is not acceptable, system operation is continued using the current system operational data and an alarm indication indicating an unacceptable state is produced.

4. An upgrade control method as claimed in claim 1, wherein, when performing an upgrade as a result of replacing a unit apparatus equipped with software, verification is made as to whether or not the software is acceptable, based on the version information of the system operational data, and if the software is acceptable, the system operational data is converted to a format recognizable by the upgraded software and the version information is updated accordingly, but if the software is not acceptable, system operation is continued using the current system operational data and an alarm indication indicating an unacceptable state is produced.

5. An upgrade control method as claimed in claim 1, wherein when the system operational data is downloaded, verification is made based on the version information to determine whether or not the downloaded system operational data is acceptable by the system and, if the system operational data is acceptable, but the version information of the system operational data is older than the current system, the system operational data is converted to a format recognizable by the current system and the version information is updated accordingly but, if the system operational data is not acceptable, system operation is continued using the current system operational data and an alarm indication is produced.

6. A data processing system in which system operational data and software are upgradable, comprising:
a system operational data storing unit which stores therein the system operational data and version information of the system operational data;
a system version management information storing unit which stores therein system acceptable software and system version information;
a database version verification unit which, when performing an upgrade, verifies based on the version information whether or not the upgrade is acceptable by the system; and
a power-up control unit which controls power-up of a system functional group only when the result of the verification in the database version verification unit shows a system acceptable state.

7. A data processing system as claimed in claim 6, comprising a database conversion unit which converts the system operational data to the latest format when the result of the verification in the database version verification unit shows a system acceptable state, and when the version of the system operational data is not the latest version.

8. A data processing system as claimed in claim 6, wherein the database version verification unit includes a facility for reporting a mismatched state to a control and monitoring terminal and causing a display unit to produced an alarm indication indicating the mismatched state when the result of the verification shows a system unacceptable state.
